(19) United States
(12) Patent Application Publication
(10) Pub. No.: US 2010/0178857 A1
(43) Pub. Date: Jul. 15, 2010

(54) HANDHELD POWER TOOL

(76) Inventor: Florian Esenwein, Uhingen-Holzhausen (DE)

Correspondence Address: MICHAEL J. STRIKER, 103 EAST NECK ROAD, HUNTINGTON, NY, 11743, US

(21) Appl. No.: 12/440,534

(22) PCT Filed: Sep. 22, 2008
(86) PCT No.: PCT/EP2008/062637

§ 371 Date: Mar. 9, 2009

(30) Foreign Application Priority Data
Nov. 5, 2007 (DE) 102007052684.0

(51) Int. Cl. B24B 23/02; B24B 55/04; B23Q 11/06

(52) U.S. Cl. 451/359; 451/451

(57) ABSTRACT

The invention is based on a handheld power tool, in particular a right-angle sander (10), having a gearbox (12), a flange neck (14) with a guard device (20), which device is receivable on the flange neck (14) and forms a receptacle region for a tool (18) and is rotatable in the circumferential direction (22), and having at least one detent device (24) for locking a rotary position of the guard device (20).

It is proposed that the detent device (24) is at least partially integrated with the flange neck (14) of the gearbox (12).

### PRIOR ART

The invention is based on a handheld power tool as generically defined by the preamble to claim 1.

From German Patent Disclosure DE 103 43 060 A1, a handheld power tool is already known that is designed as a right-angle sander. The right-angle sander has a gearbox, with a driven shaft emerging from the gearbox and with a gear flange located on the gearbox and forming a flange neck. A guard device that is rotatable in the circumferential direction is received on the flange neck. The rotary position of the guard device in the circumferential direction can be locked with a detent lever, which in its position of repose generates a form lock with the guard device. The detent lever is located transversely to the longitudinal axis of the right-angle sander on the gearbox.

### ADVANTAGES OF THE INVENTION

The invention is based on a handheld power tool, in particular a right-angle sander, having a gearbox, a flange neck with a guard device, which device can be received on the flange neck and forms a receptacle region for a tool and can be rotated in the circumferential direction, and having at least one detent device for locking a rotary position of the guard device.

It is proposed that the detent device is at least partially integrated with the flange neck, which in particular is embodied on or integrally formed onto the gearbox. The wording “integrated with the flange neck” is to be understood here in particular to mean located inside the flange neck, received in the flange neck, fitted into the flange neck, and/or embodied in one piece with the flange neck. This makes it possible to use the space that already exists in the gearbox or in the flange neck. In addition, a majority of the components of the detent device are protected against dust and damage in the gearbox or in the flange neck, since for the most part the components are surrounded by the receiving collar of the guard device. Locking that reliably prevents the guard device from being rotated out of a defined position of over 90° is assured. Advantageously, very simple user operation of the detent device is possible without a tool.

It is proposed that the locking is effected radially, beginning at the flange neck toward the guard device. This is to be understood in particular to mean that the locking motion or the motion of the detent device is effected radially, or in other words that the motion is executed in the radial direction. Advantageously, the majority of the detent device can thus be integrated with the flange neck.

Advantageously, the locking of the guard device is effected axially as well. Thus the guard device is secured not only radially but also axially against rotation or displacement. This should be understood in particular to mean that the locking can also be effected in some other direction than the axial direction yet nevertheless acts in the axial direction.

It is furthermore proposed that the locking is effected via a form lock between the detent device and the guard device. As a result, an especially secure locking of the guard device on the flange neck is assured.

One possibility of implementing the form lock in a way that is very simple to produce provides that the detent device includes at least one detent element and at least one detent element receptacle cooperating with the detent element.

It is proposed that the detent element receptacle is embodied on the guard device, as a result of which simple production of the guard device is attainable.

Advantageously, in the unlocked state, the detent element is located in the flange neck, and as a result the guard device can be rotated and repositioned on the flange neck. The term “located” should be understood in particular to mean “accommodated” or “received”.

Alternatively to this, it is proposed that a plurality of detent elements are embodied on the guard device. The axial securing of the guard device is improved as a result, since these detent elements are guided all the way around in a groove in the flange neck, thereby preventing the guard device from slipping off axially.

One way of implementing the detent element receptacle in an especially simply produced and space-saving way provides that the detent element receptacle is a recess or an indentation.

It is proposed that the detent device has at least one sprina device, as a result of which, advantageously automatically, a durable form lock is generated between the guard device and the detent device and can be released at any time, preferably manually and with little expenditure of force.

Because the spring device acts upon the detent device, beginning at the flange neck, toward the guard device, the use of the space already present in the gearbox or in the flange neck is possible. In addition, the spring device is protected in the gearbox or in the flange neck from dirt and damage, since the gearbox and the flange neck are surrounded by the receiving collar of the guard device.

To make a space-saving detent device possible that is easy to install and use, it is proposed that the detent element and/or the detent element receptacle is located on a detent slide. Alternatively, it is proposed that the detent element and/or the detent element receptacle is located on a detent lever. As a result, it is possible to release the form lock between the guard device and the flange neck resulting from the lever action with very little expenditure of force.

It is furthermore proposed that the detent slide and/or the detent lever is designed such that the guard device rests flush on the gearbox, thereby making problem-free rotation and repositioning of the guard device on the flange neck possible.

It is proposed that the detent lever can be rotated about an axis located in the flange neck, as a result of which it is possible to use the already existing space in the gearbox or the flange neck for the detent device.

It has proved especially expedient that the release of the locking is effected via pressing of the detent slide and/or the detent lever.

Alternatively, releasing the locking can be done by pulling the detent lever.

To achieve greater stability of the right-angle sander and in particular of the guard device, a stabilizing neck is provided, which at least partly surrounds a receiving collar of the guard device.

Advantageously, the stabilizing neck has at least one detent element and/or at least one detent element receptacle. As a result, it is possible for the detent element to engage not only the guard device or the receiving collar of the guard device but also the stabilizing neck, so that an even higher force flow from the guard device to the flange neck or the gearbox is made possible.

It has proved especially expedient if the stabilizing neck has a tightening device, since as a result any play between the stabilizing neck and the guard device can be compensated for.

### DRAWINGS

Further advantages will become apparent from the ensuing description of the drawings. In the drawings, an exemplary embodiment of the invention is shown. The drawings, specification and claims include numerous characteristics in combination. One skilled in the art will expediently consider the characteristics individually as well and put them together to make useful further combinations.

Shown are:

FIG. 1, part of a handheld power tool in an exploded view, with a guard hood and with a detent device according to the invention, in a first embodiment;

FIG. 2, a plan view on the gear flange of the handheld power tool, having the detent device of the invention, in a first embodiment;

FIG. 3, a top view on a gear flange of a handheld power tool, with a detent device of the invention, in a second embodiment;

FIG. 4, a perspective view of part of a detent device of the invention, in a third embodiment;

FIG. 5, a plan view on the gear flange of the handheld power tool, having the detent device of the invention, in a fourth embodiment;

FIG. 6, a perspective view of part of a detent device of the invention, in the fourth embodiment;

FIG. 7, a plan view on the gear flange of the handheld power tool, having the detent device of the invention, in a fifth embodiment; and

FIG. 8, a plan view on the gear flange of the handheld power tool, having the detent device of the invention, in a sixth embodiment.

### DESCRIPTION OF THE EXEMPLARY EMBODIMENTS

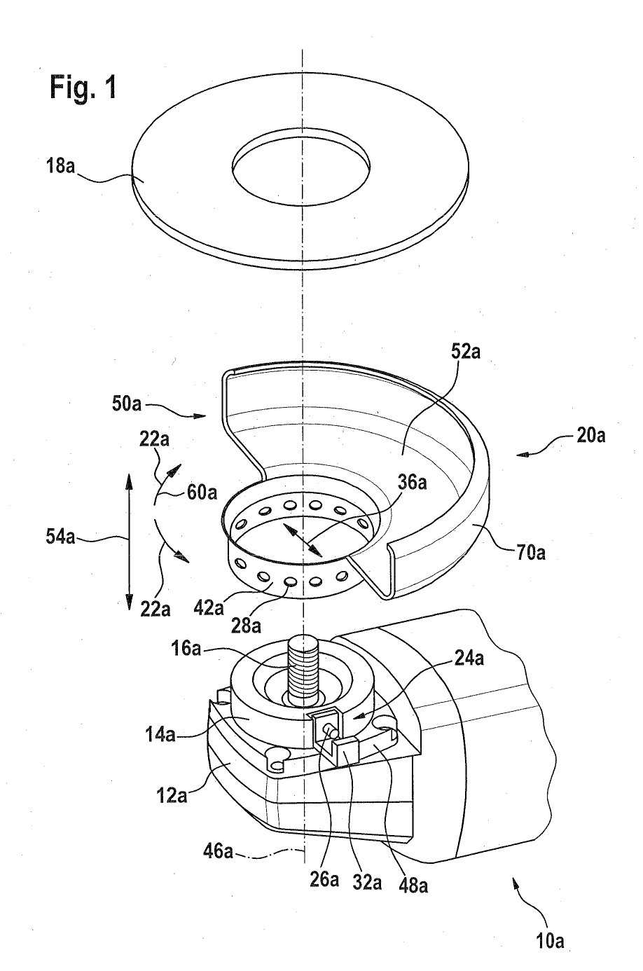

FIG. 1 shows part of a handheld power tool. In the present exemplary embodiments, the handheld power tool is a right-angle sander 10. The right-angle sander 10 has a gearbox 12. A driven shaft 16 protrudes from the gearbox 12 and on its free end has a disklike tool 18, such as a sanding wheel that is driven to rotate about an axis 46 of the driven shaft 16. The driven shaft 16 is rotatably supported in a bearing, not visible here, which in the present exemplary embodiments is received by a gear flange 48 embodied by the gearbox 12. The gearbox 12 forms a freely protruding, cylindrical flange neck 14, which adjoins the gear flange 48 and fits around the driven shaft 16.

The flange neck 14, on its outer circumference, receives a guard device, in the form of a guard hood 20. The guard hood 20 includes a base body 50 and a receiving collar 42, which is joined to the base body 50 and forms a central opening for free passage through it of the driven shaft 16. The receiving collar 42 is embodied as a cylindrical body that extends parallel to the flange neck 14. The base body 50 is provided for protecting a user of the handheld power tool against sparks and/or particles of material that occur during the operation of the handheld power tool. To that end, the base body 50 is formed by a platelike element 52, which has a semicircular embodiment, and the platelike element 52 covers an angular range of approximately 180° of the tool 18. As a result, sparks and/or any particles of material are carried toward the front, away from the user. A guard rim 70 is located on the platelike element 52 and is oriented initially at right angles to the platelike element 52 and then parallel to the platelike element 52.

The guard hood 20 is fitted with the receiving collar 42 onto the flange neck 14 and should have only little play on the flange neck 14. Optionally, via a compensation element, such as a rubber ring, not shown here, the play between the guard hood 20 and the flange neck 14 can be eliminated, at least partially. For readjusting the diameter of the receiving collar 42, for instance in order to compensate for wear, the receiving collar 42 of the guard hood 20 may furthermore be embodied as a kind of clamping cuff, with the readjustment being effected by way of tightening a screw.

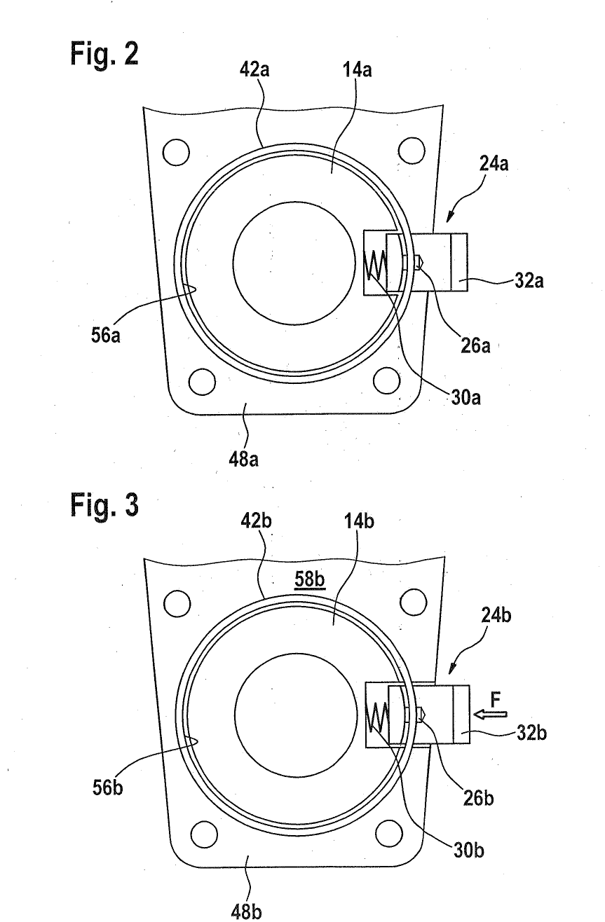

The guard hood 20 is rotatable in the circumferential direction 22 on the flange neck 14. For locking a rotary position of the guard hood 20, or in other words for radially locking the guard hood 20 on the flange neck 14, a detent device 24 is provided as shown in FIGS. 1 through 8. According to the invention, the detent device 24 is integrated at least partially with the flange neck 14 of the gear flange 48. In the present exemplary embodiments, a majority of the components of the detent device 24 are integrated with the flange neck 14, and these components are surrounded there by the receiving collar 42 of the guide hood 20.

In the present exemplary embodiments in FIGS. 1 through 8, the locking is effected radially, beginning at the flange neck 14, toward the guard hood 20. Preferably, the locking of the guard hood 20 is effected via a form lock between the detent device 24 and the guard hood 20. The detent device 24 here includes at least one detent element 26 and at least one detent element receptacle cooperating with the detent element 26; the detent element is preferably a bolt 26, and the detent element receptacle is a recess 28 or an indentation. The detent device 24 has at least one spring device 30, which beginning at the flange neck 14 urges the detent device 24 toward the guard hood 20.

To secure the guard hood axially on a handheld power tool, an additional axial securing means is typically provided. As a rule, these are pins, provided in the receiving collar of the guard hood, which engage an encompassing groove 72 in the flange neck. This additional locking can be dispensed with because of the detent device 24 of the invention. In the present case, the locking according to the invention acts, in addition to a radial direction 36, in an axial direction 54 as well. However, one skilled in the art may nevertheless provide an additional axial securing means, if that appears useful to him.

FIGS. 1 through 8 show a plurality of exemplary embodiments of the invention. In FIGS. 1 through 4, the detent device 24a through 24c is embodied as a detent slide 32a through 32c, and in FIGS. 5 through 7, the detent device 24d through 24f is embodied as a detent lever 34d through 34f. The detent element 26a through 26f of the detent device 24a through 24f may be embodied on the guard hood 20a through 20f or on the detent slide 32a through 32f or on the detent lever 34a through 34f, and the detent element receptacle 28a through 28f may be embodied on the detent slide 32a through 32f or on the detent lever 34a through 34f or on the guard hood 20a through 20f.

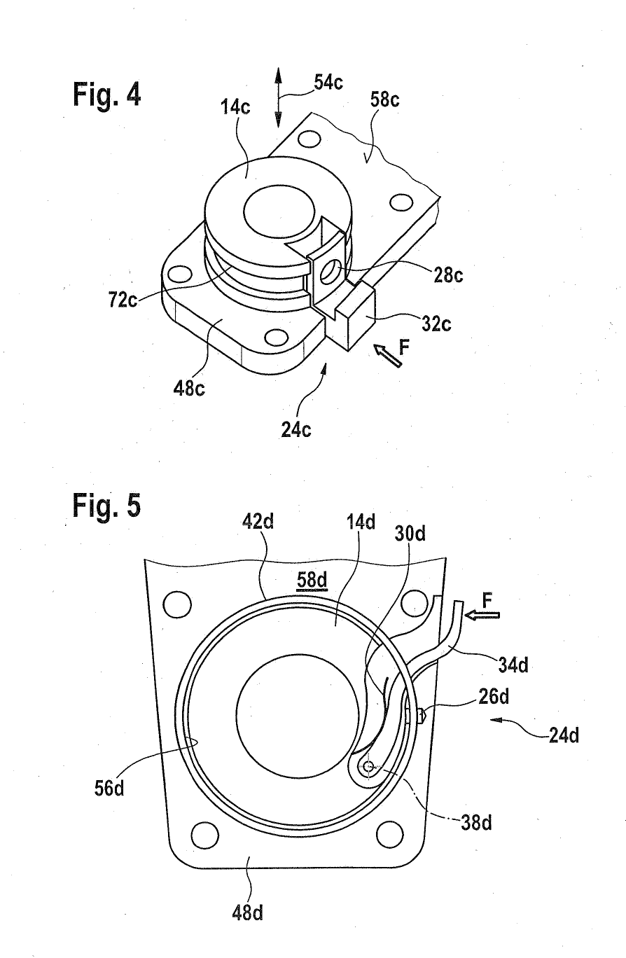

FIGS. 1 through 4 show a gear flange 48a through 48c with an integrated detent slide 32a through 32c in the locked state, in which the detent slide 32a through 32c is in engagement with the guard hood 20a through 20c; that is, in the present exemplary embodiments in FIGS. 1 through 3, a bolt 26a, 26b is embodied on the detent slide 32a, 32b and in the locked state of the detent device 24a, 24b engages a recess 28a, 28b of the receiving collar 42a, 42b of the guard hood 20a, 20b. Conversely, in FIG. 4, it is also possible to provide a recess 28c on the detent slide 32c and a bolt 26c on the guard hood 20c. It is moreover possible to provide a plurality of bolts 26a through 26c and recesses 28a through 28c on the detent slide 32a through 32c and on the guard hood 20a through 20c, respectively, in order to enable a greater flow of force from the flange neck 14a through 14c to the guard hood 20a through 20c. During locking, the detent slide 32a through 32c is displaced with the bolt 26a through 26c in the radial direction 36, in that by way of the spring device 30a through 30c, embodied for instance as a compression spring, the detent slide is pressed against an inner wall 56a through 56c of the receiving collar 42a through 42c of the guard hood 20a through 20c. Next, the guard hood 20a through 20c is rotated in the circumferential direction 22a through 22c until such time as the bolt 26a through 26c and a recess 28a through 28c in the receiving collar 42a through 42c are diametrically opposite one another and the bolt 26a through 26c, by the force of the spring device 30a through 30c, moves into the recess 28a through 28c and thereby generates a form lock between the flange neck 14a through 14c and the guard hood 20a through 20c. To release the form lock and to attain the unlocked state, the detent slide 32a through 32c merely has to be pressed in the radial direction 36a through 36c into the flange neck 14a through 14c counter to the force of the spring device 30a through 30c, so that the bolt 26a through 26c becomes disengaged, or in other words so that the detent element 26a through 26c embodied as a bolt is located in the flange neck 14a through 14c. In the unlocked state of the detent device 24a through 24c, the guard hood 20a through 20c can now be rotated and repositioned on the flange neck 14a through 14c.

FIGS. 3 and 4 show that the detent slide 32b, 32c is designed such that the guard hood 20b, 20c rests with its receiving collar 42b, 42c flush on the gear flange 48b, 48c. This is attained by providing that the detent slide 32b, 32c is let axially into the gear flange 48b, 48c, as a result of which a flat bearing face 58b, 58c in the axial direction 54b, 54c is created for the receiving collar 42b, 42c of the guard hood 20b, 20c.

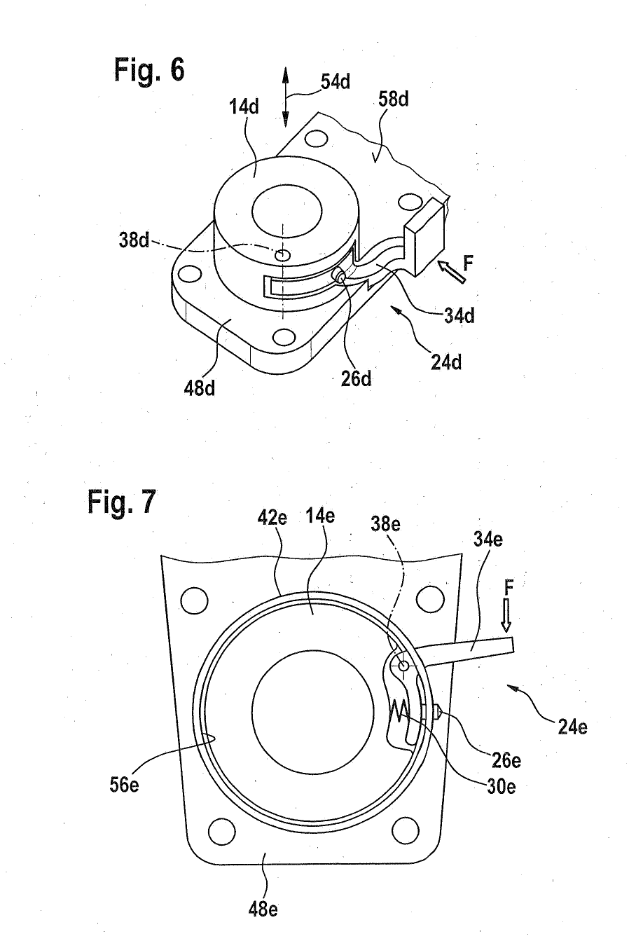

FIGS. 5 through 7 show a gear flange 48d through 48f with an integrated detent lever 34d through 34f in the locked state, in which the detent lever 34d through 34f is in engagement with the guard hood 20d through 20f; that is, in the present exemplary embodiment, a bolt 26d through 26f which in the locked state of the detent device 24d through 24f engages a recess 28d through 28f of the receiving collar 42d through 42f of the guard hood 20d through 20f is embodied on the detent lever 34d through 34f. Conversely to this, it is also possible to provide a recess 28d through 28f on the detent lever 34d through 34f and a bolt 26d through 26f on the guard hood 20d through 20f. It is furthermore also possible to provide a plurality of bolts 26d through 26f and recesses 28d through 28f on the detent lever 34d through 34f and on the guard hood 20d through 20f, respectively, in order to enable a greater flow of force from the flange neck 14d through 14f to the guard hood 20d through 20f. The detent lever 34d through 34f is rotatable about an axis 38d through 38f that is located in the flange neck 14d through 14f. During locking, the detent lever 34d through 34f is rotated with the bolt 26d through 26f about the axis 38d through 38f, in that, via the spring device 30d through 30f, embodied for instance as a leaf spring, the detent lever is pressed against an inner wall 56d through 56f of the receiving collar 42d through 42f of the guard hood 20d through 20f. Next, the guard hood 20d through 20f is rotated in the circumferential direction 22d through 22f until such time as the bolt 26d through 26f and a recess 28d through 28f in the receiving collar 42d through 42f are diametrically opposite one another, and the bolt 26d through 26f, by the force of the spring device 30d through 30f, moves into the recess 28d through 28f and thereby creates a form lock between the flange neck 14d through 14f and the guard hood 20d through 20f. In other words, by way of the spring device 30d through 30f, the detent lever 34d through 34f is always automatically put into engagement whenever the bolt 26d through 26d and the recess 28d through 28f are diametrically opposite one another, and no force is being exerted on the detent lever 34d through 34f. Advantageously, the detent lever 34d upon rotation of the guard hood 20d, in the present exemplary embodiment of FIGS. 5 and 6, in the clockwise direction 60d becomes more and more tightly clamped, so that self-locking of the detent lever 34d occurs. Depending on the design of this detent device 24d, it is possible for rotation of the detent lever 34d counter to the clockwise direction 60d, for the bolt 26d to be pressed out of the recess 28d in the guard hood 20d, thus making overlocking possible, for instance to enable a quick adjustment of the guard hood 20d in one direction.

To release the form lock and to attain the unlocked state, the detent lever 34d through 34f merely has to be pressed in the direction of the flange neck 14d through 14f, counter to the force of the spring device 30d through 30f, so that the bolt 26d through 26f becomes disengaged, or in other words the detent element 26d through 26f, embodied as a bolt, is located in the flange neck 14d through 14f. In the unlocked state of the detent device 24d through 24f, the guard hood 20d through 20f can now be rotated and repositioned on the flange neck 14d through 14f.

FIGS. 5 and 6 show that the detent lever 34d is designed such that the guard hood 20d, with its receiving collar 42d, can rest flush on the gear flange 48d. This is attained by providing that the detent lever 34d is let axially into the gear flange 48d, thereby creating a flat bearing face 58d for the receiving collar 42d of the guard hood 20d in the axial direction 54d.

Besides the position of the axis of rotation 38 for the detent lever variant described, still other positions of the axis of rotation 38 that appear useful to one skilled in the art can be imagined that make it possible to disengage the bolt. In FIG. 7, for instance, the detent device 24e is designed such and the axis of rotation 38e is positioned such that for releasing the form lock and attaining the unlocked state, the detent lever 34e must be pulled in the direction of the flange neck 14e, counter to the force of the spring device 30e, so that the bolt 26e becomes disengaged, or in other words so that the detent element 26e embodied as a bolt is located in the flange neck 14e.

It is also possible to provide a plurality of detent slides 32 and/or detent levers 34 in a handheld power tool 10, so that for instance one detent slide 32 is provided on the right and one detent slide 32 on the left of the handheld power tool 10. When the two detent slides 32 embrace the machine 10 from above and are actuated, the guard hood 20 is released to rotate. Both for the detent slide 32 and for the detent lever 34, it is provided that by way of the displacement of the detent slide 32 or the pressing or pulling the detent lever 34, the form lock between the guard hood 20 and the detent device 24 is released, so that no additional tool is needed for adjusting the guard hood 20. However, it is also conceivable that for instance via a screw, not shown here, a feeding means is created, which is mounted on the detent slide 32 or the detent lever 34, by which the bolt 26 is then disengaged.

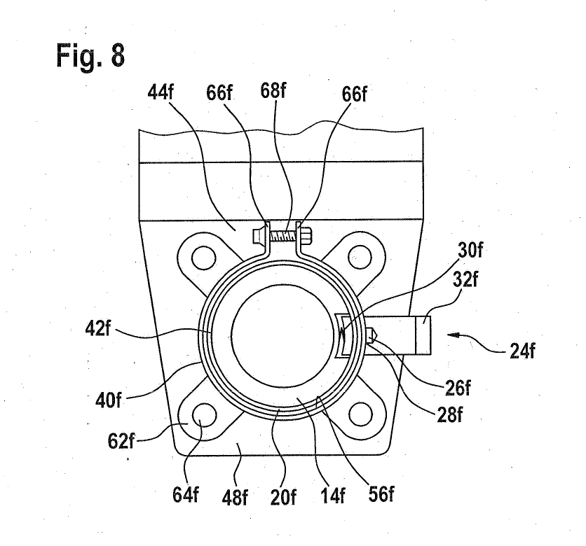

FIG. 8 shows a further variant embodiment of the right-angle sander 10f with a stabilizing neck 40f. FIG. 8 shows the gear flange 48f with the flange neck 14f that receives the guard hood 20f on its outer circumference. In this embodiment of the invention, the stabilizing neck 40f is additionally provided, which at least partly surrounds the receiving collar 42f of the guard hood 20f. The stabilizing neck 40f may be advantageously secured to the gear flange 48f via securing means 62f; as the securing means 62f, any means appearing useful to one skilled in the art can be employed. In the present exemplary embodiment, the stabilizing neck 40f for the securing has securing feet 62f, which are connected to the gear flange 48f via screw connections 64f. To compensate for play between the stabilizing neck 40f and the guard hood 20f, the stabilizing neck 40f has a tightening device 44f, which can also additionally be provided as a securing means. In the present case, two angled ends 66f of the stabilizing neck 40f serve as the tightening device 44f and can be tightened against one another via a screw 68f. The stabilizing neck 40f has at least one detent element 26f and/or at least one detent element receptacle 28f.

1. A handheld power tool, in particular a right-angle sander (10), having a gearbox (12), a flange neck (14) with a guard device (20), which device is receivable on the flange neck (14) and forms a receptacle region for a tool (18) and is rotatable in the circumferential direction (22), and having at least one detent device (24) for locking a rotary position of the guard device (20), characterized in that the detent device (24) is at least partially integrated with the flange neck (14).

2. The handheld power tool as defined by claim 1, characterized in that the locking is effected radially, beginning at the flange neck (14) toward the guard device (20).

3. The handheld power tool as defined by claim 1, characterized in that the locking of the guard device (20) acts axially as well.

4. The handheld power tool as defined by claim 1, characterized in that the locking is effected via a form lock between the detent device (24) and the guard device (20).

5. The handheld power tool as defined by claim 1, characterized in that the detent device (24) includes at least one detent element (26) and at least one detent element receptacle (28) cooperating with the detent element (26).

6. The handheld power tool as defined by claim 5, characterized in that the detent element receptacle (28) is embodied on the guard device (20).

7. The handheld power tool as defined by claim 6, characterized in that in the unlocked state, the detent element (26) is located in the flange neck (14).

8. The handheld power tool as defined by claim 5, characterized in that a plurality of detent elements (26) are embodied on the guard device (20).

9. The handheld power tool as defined by claim 5, characterized in that the detent element receptacle is a recess (28) or an indentation.

10. The handheld power tool as defined by claim 1, characterized in that the detent device (24) has at least one spring device (30).

11. The handheld power tool as defined by claim 10, characterized in that the spring device (30) acts upon the detent device (24), beginning at the flange neck (14), toward the guard device (20).

12. The handheld power tool as defined by claim 5, characterized in that the detent element (26) and/or the detent element receptacle (28) is located on a detent slide (32) and/or on a detent lever (34).

13. The handheld power tool as defined by claim 12, characterized in that the detent slide (32) is displaceable in the radial direction (36).

14. The handheld power tool as defined by claim 12, characterized in that the detent slide (32) and/or the detent lever (34) is designed such that the guard device (20) rests flush on the gearbox (12).

15. The handheld power tool as defined by claim 12, characterized in that the detent lever (34) is rotatable about an axis (38) located in the flange neck (14).

16. The handheld power tool as defined by claim 12, characterized in that the release of the locking is effected via pressing of the detent slide (32) and/or the detent lever (34).

17. The handheld power tool as defined by claim 12, characterized in that the release of the locking is effected via pulling of the detent lever (34).

18. The handheld power tool as defined by claim 1, characterized by a stabilizing neck (40), which at least partly surrounds a receiving collar (42) of the guard device (20).

19. The handheld power tool as defined by claim 18, characterized in that the stabilizing neck (40) has at least one detent element (26) and/or at least one detent element receptacle.

20. The handheld power tool as defined by claim 18, characterized in that the stabilizing neck (40) has a tightening device (44).
